(19) United States
(12) Patent Application Publication
(10) Pub. No.: US 2006/0192757 A1
(43) Pub. Date: Aug. 31, 2006

(54) Receiver accommodative wireless input equipment

(75) Inventor: Chih-Chien Chen, Yonghe City (TW)

Correspondence Address: HDSL, 4331 STEVENS BATTLE LANE, FAIRFAX, VA, 22033, US

(73) Assignee: Chic Technology Corp.

(21) Appl. No.: 11/066,469

(22) Filed: Feb. 28, 2005

(51) Int. Cl. G09G 5/08

(52) U.S. Cl. 345/163

(57) ABSTRACT

A receiver accommodative wireless input equipment includes a main input unit, such as a mouse, a magnetic element, a magnetic inductor, and a receiver. The main input unit has an accommodation cavity in which the built-in magnetic element and the receiver are accommodated. The magnetic inductor is attached to one side of the receiver. With this structure the receiver can be settled statically in the accommodation cavity by the magnetic attraction force of the magnetic element exerted to the magnetic inductor attached to the receiver.

### BACKGROUND OF THE INVENTION

1. Field of the invention

The present invention relates to a receiver accommodative wireless input equipment, which is able to accommodate a receiver in its particularly prepared accommodation cavity, and set the receiver stably in its position by the magnetic attraction force.

2. Description of the Prior Art

At present, a mouse, which is an input equipment, has become one of the most important peripheral equipment for the computer, and its field of application is widely expanding. Due to in need of signal wire connection with the main computer, the conventional mouse has to confine its movable range in a restricted area. For an improvement, a wireless mouse appeared on the market before long, this mouse is equipped with a receiver to communicate with the main computer instead of signal wire connection. The improvement by ridding signal wire connection enables the mouse to freely movable right to left on the desk during at work, or to be put away in the user's pocket, in the keyboard drawer, or somewhere at the place in the office distantly away from the computer. The workable range of the mouse has been enlarged and the operation become much easier and more convenient because there are no longer those annoying signal wires tangling on the desk.

Now the problem arises, the receiver, the communication medium between the computer and the mouse is usually attached to the computer causing it to become bulky and the receiver is apt to be lost when removing the computer installation.

As an improvement “Receiver accommodative wireless input equipment” was patented in Taiwan (Pat. No. 560,653) recently. In this cited case, an accommodation space for a receiver is provided in the wireless mouse and the receiver is settled in there by a hasp mechanism.

Soon several problems has been found with this product:

1. The extra accommodation space and hasp mechanism for the receiver makes the construction of the mouse complicated and hard to mold and assemble with a low cost.

2. The structure of the mouse can not stand frequent installation and detachment of the receiver, and soon fails to accommodate the receiver properly.

Another analogous product was patented in Taiwan (Pat. No. 584,252) not very long after the first one. In this second cited case a central frame with an accommodation space configurated in similar figure with the receiver and having slightly larger space to accommodate it, is provided in the mouse. With this structure, it has been soon found to be problematic that frequent open/close operation of the entire cover of the mouse for installing and detaching the receiver will shorten the lifetime of the mouse itself by fatiguing its mechanical strength and introducing dust to infringe into its inner portion.

The third improved mouse appeared on the market provides a port on the upper lid of the mouse communicating with an accommodation space underneath and a movable lid is provided to cover the port so as to get rid of the shortcomings of the second one. By so, there are following problems remain unovercome:

1. The receiver contained in the mouse can not fully avoid dropping out of the mouse by violent vibration or overturning in spite of covering with a movable lid on it.

2. The port is limited to be open at the side or on top of the upper lid of the mouse. If it is opened at the bottom of the mouse, the receiver can not be held securely in the mouse but drops down by its own weight.

It is what the reason the inventor has put forth every effort for years by continuous research and experimentation attempting to find out the remedy to palliate the inherent shortcomings of the conventional wireless mice described above, and at last has succeeded in realizing the present invention.

### SUMMARY OF THE INVENTION

Accordingly, the present invention is to provide a receiver accommodative wireless input equipment which can provide a reliable accommodation cavity to hold the receiver in it without changing the construction of the original input equipment too much, and such an accommodation cavity can be made easily with a low cost.

Accordingly, the present invention comprises a main input unit in which an accommodation cavity is provided, a magnetic element contained in the accommodation cavity and a receiver properly accommodated in there with a magnetic inductor installed at one end of the receiver to be magnetically coupled with the magnetic element.

### BRIEF DESCRIPTION OF THE DRAWINGS

The drawings disclose several illustrative embodiments of the present invention which serve to exemplify the various advantages and objects hereof, and are as follows:

FIG. 1 is a three dimensional exploded view of the present invention;

FIG. 2 is a perspective view of the present invention;

FIG. 3 is a perspective view of the receiver provided in the present invention;

FIG. 4 is a schematic view of the receiver in a first embodiment.

FIG. 5 is an illustrative view showing the magnetic inductor is erected to serve as an antenna in a second embodiment;

FIG. 6 is an illustrative view showing the magnetic inductor is stowed in its place in a second embodiment; and

FIG. 7 to FIG. 9 are respectively the schematic views of the receiver in embodiments from third to fifth of the present invention.

### DETAILED DESCRIPTION OF THE PREFERRED EMBODIMENT

Hereinbelow, the preferred embodiment of the present invention will be described in detail in conjunction with the attached drawings.

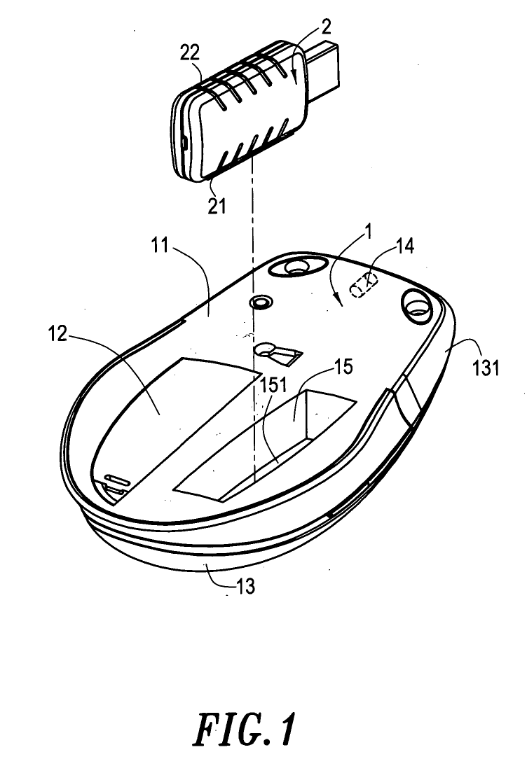

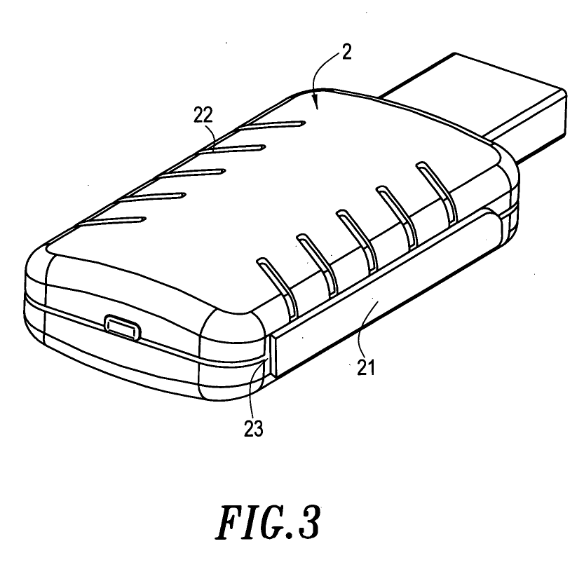

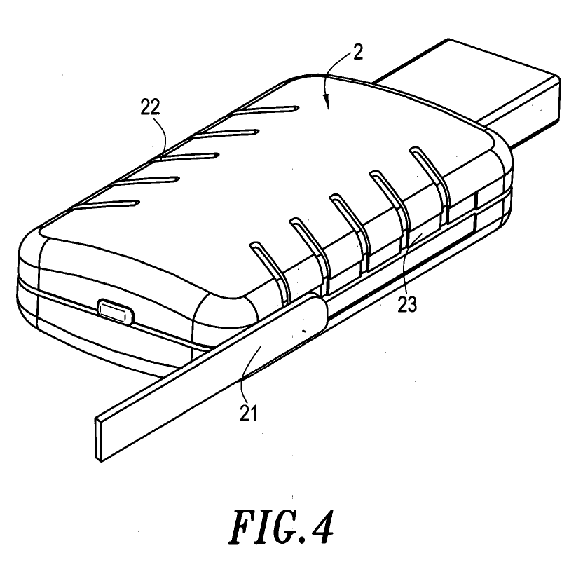

As shown in FIGS. 1 through 4, the present invention comprises a main input unit 1, and a receiver 2. Wherein the main input unit is a computer mouse to operate the computer. The main input unit 1 further includes a base 11 with a power source 12 attached to it, and a lid 13 covering the base 11, the lid 13 has several control buttons 131 disposed on it, and a transmitter 14 is equipped at the front end of the lid 13. An accommodation cavity 15 is formed between the lid 13 and the base 11 with a magnetic element 151 built in it.

The receiver 2 that is appropriately settled in the accommodation cavity 15 has a plurality of grooves 22 formed on its both side surfaces. The receiver 2 further has a slide slot 23 formed at its one side, the slide slot 23 has an opening at its front end. A long bar shaped magnetic inductor 21 is provided in the slide slot 23 to be magnetically coupled with the magnetic element 151. The magnetic inductor 21 is able to slide to and fro in the slide slot 23, and is also can serve as a receiving antenna to receive the signal from the transmitter 14.

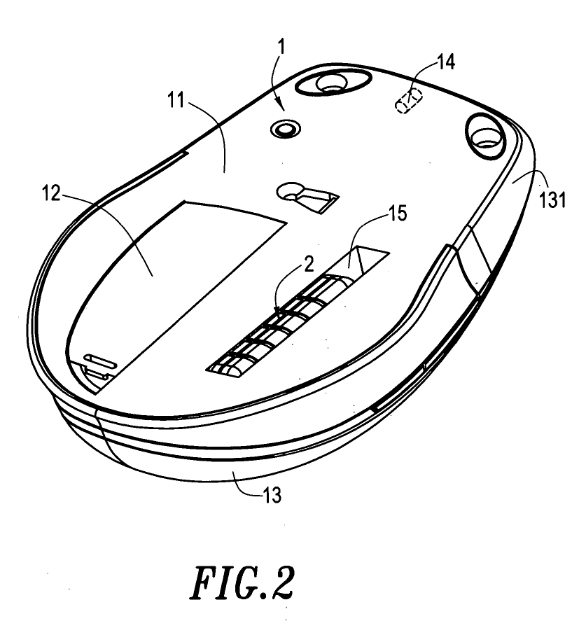

Referring simultaneously to FIGS. 2 through 4, by placing the receiver 2 in the accommodation cavity 15 of the main input unit 1 in the manner aligning the magnetic inductor 21 to the magnetic element 151 in a magnetically coupled position such that the two elements are mutually attractive with their magnetic force thereby settling down the receiver 2 statically in its position. When taking out the receiver 2, the operator can easily remove the receiver 2 by tenderly scratching its grooves 22 with his/her finger so as to separate its magnetic inductor 21 from the magnetic element 151. Meanwhile, when the receiver 2 is inserted to the main computer, the magnetic inductor 21 is slid out of the slide slot 23 to serve as a receiving antenna to receive the signal outputted from the main input unit 1.

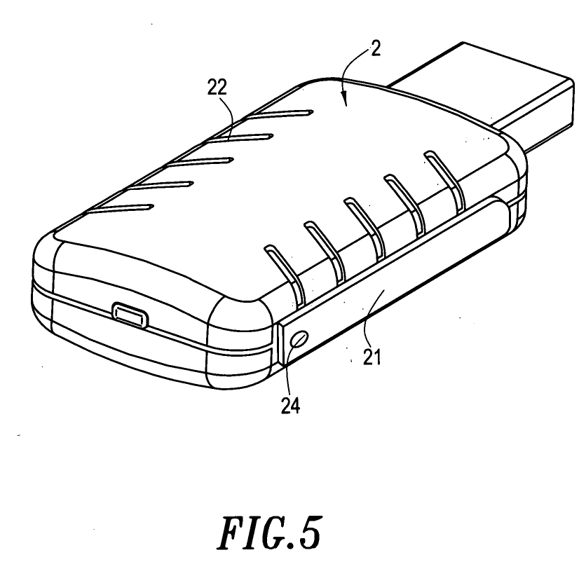

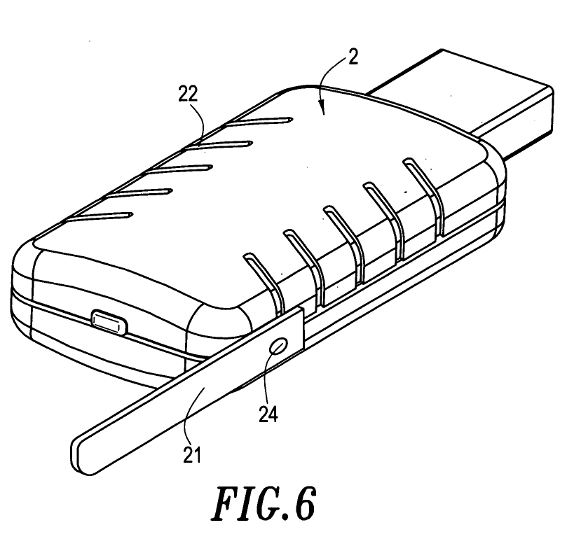

In the second embodiment shown in FIGS. 5 and 6, the magnetic inductor 21 is hinged to one side of the receiver 2 with a hinge pin 24.

Referring to FIGS. 5 and 6 together with FIG. 2, when the receiver 2 is inserted to the main computer, the magnetic inductor 21 can be erected by swinging up about the hinge pin 24 to serve as a receiving antenna, and stowed in the receiver 2 by swinging down to its original position while the receiver 2 is settled back in the accommodation cavity 15.

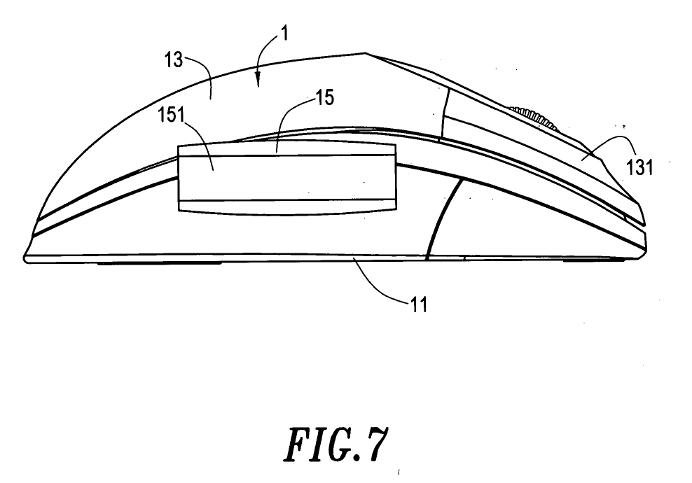

In the third embodiment shown in FIG. 7, the accommodation cavity 15 is formed at lower side of the main input unit 1 under the lid 13.

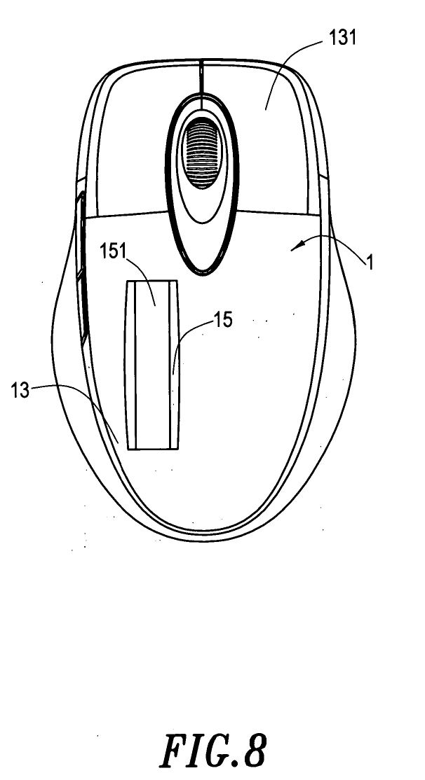

In the fourth embodiment shown in FIG. 8, the accommodation cavity 15 is formed near the top portion of the main input unit 1 under the lid 13.

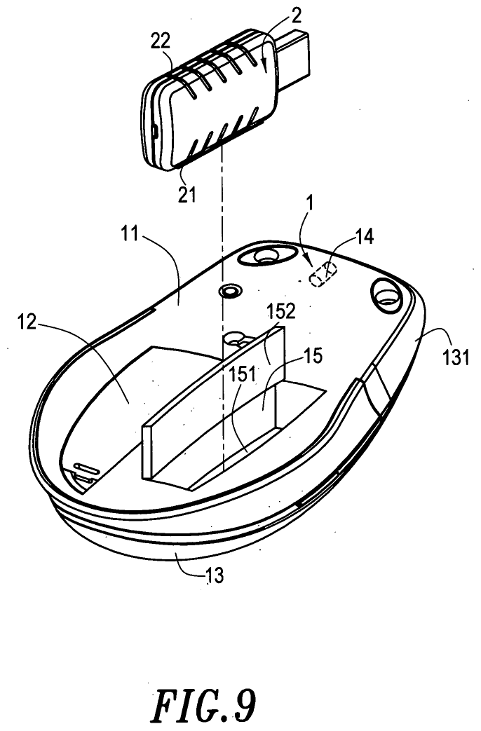

In the fifth embodiment shown in FIG. 9, the opening of the accommodation cavity 15 is enclosed with a cover plate 152 so as to keep the receiver 2 in a clean state by preventing infringement of dust and other foreign material.

A magnetic shield substance can be spread in the accommodation cavity 15 to confine the magnetic attraction force of the magnetic element 151 in a defined range so as to protect the main input unit 1 from magnetic interference.

Besides, the main input unit may be replaced by a wireless keyboard with an accommodation cavity 15 formed at its one side to accommodate the receiver 2.

It emerges from the above description that the present invention has several noteworthy advantages namely:

1. The receiver may be stably settled in the accommodation cavity of the mouse by the collaborated magnetic function between the magnetic element and the magnetic inductor thereby facilitating the user to take out or stow the receiver conveniently.

2. The accommodation cavity can be easily formed in various positions in the mouse easily without the need of sophisticated design to change the construction of a common mouse.

Only several preferred embodiments of the present invention and a few examples of its versatility are shown and described in the present disclosure. It is to be understood that the present invention is capable of use in various other combination and environments and is capable of changes or modifications within the scope of inventive concept as expressed herein.

What is claimed is:

1. A receiver accommodative wireless input equipment comprising:
a main input unit having an accommodation cavity therein, and a magnetic element being built in the accommodation cavity;
a receiver settled in the accommodation cavity, and a magnetic inductor being installed on one side thereof to be magnetically coupled with the magnetic element;
wherein the receiver is held statically in the accommodation space by a magnetic attraction force generated between the magnetic element and the magnetic inductor.

2. The wireless input equipment as in claim 1, wherein the magnetic inductor is a receiving antenna.

3. The wireless input equipment as in claim 2, wherein the magnetic inductor is formed into long bar shape.

4. The wireless input equipment as in claim 3, wherein the receiver has a front end opened slide slot formed at one side thereof so as to place the magnetic inductor slidably therein to move along to and fro.

5. The wireless input equipment as in claim 3, wherein the magnetic inductor is hinged to one side of the receiver with a hinge element.

6. The wireless input equipment as in claim 5, wherein the hinge element is a hinge pin.

7. The wireless input equipment as in claim 1, wherein the receiver has a plurality of grooves formed on both side surfaces thereof.

8. The wireless input equipment as in claim 1, wherein the main input unit is a computer mouse.

9. The wireless input equipment as in claim 1, wherein the main input unit has a base with a power source attached thereto; a lid covering the base, wherein the lid is provided with several control buttons disposing thereon; and a transmitter equipped at the front end of the lid.

10. The wireless input equipment as in claim 9, wherein the accommodation cavity is formed at lower side of the main input unit under the lid.

11. The wireless input equipment as in claim 9, wherein the accommodation cavity is formed at one side of the main input unit under the lid.

12. The wireless input equipment as in claim 9, wherein the accommodation cavity is formed near the top portion of the main input unit under the lid.

13. The wireless input equipment as in claim 1, wherein the opening of the accommodation cavity is enclosed with a cover plate.

14. The wireless input equipment as in claim 1, wherein a magnetic shield substance is spread in the accommodation cavity to confine the magnetic field of the magnetic element in a defined range.

15. The wireless input equipment as in claim 1, wherein the main input unit is a wireless key board.
